(19) United States
(12) Patent Application Publication
(10) Pub. No.: US 2024/0030761 A1
(43) Pub. Date: Jan. 25, 2024

(54) ROTOR AND ROTATING ELECTRIC MACHINE

(71) Applicant: DENSO CORPORATION, Kariya-city (JP)

(72) Inventors: Toshihiro UCHIDA, Kariya-city (JP); Ritsuro HIRAMATSU, Kariya-city (JP)

(73) Assignee: DENSO CORPORATION, Kariya-city (JP)

(21) Appl. No.: 18/376,996

(22) Filed: Oct. 5, 2023

Related U.S. Application Data
(63) Continuation of application No. PCT/JP2022/016549, filed on Mar. 31, 2022.

(30) Foreign Application Priority Data
Apr. 5, 2021 (JP) 2021-064255

(51) Int. Cl. H02K 1/276; H02K 1/16

(52) U.S. Cl. CPC H02K 1/276; H02K 1/16; H02K 2213/03

(57) ABSTRACT

A rotor has a plurality of magnetic poles each including one of permanent magnets and one of outer core portions. Each of the outer core portions has a radially outer surface that has an arc shape such that the radially outer surface becomes closer to a rotation axis of the rotor as it extends from a magnetic-pole center of the magnetic pole toward both sides in a circumferential direction. A reference circle is defined which has a diameter equal to a maximum diameter of the rotor core and centers on the rotation axis. An outer circumferential surface of the rotor core has, at intersections between the arc-shaped radially outer surfaces of the outer core portions, maximum displacement portions that are most displaced from the reference circle radially inward. A displacement amount of the maximum displacement portions from the reference circle is smaller than a maximum thickness of the permanent magnets.

### CROSS-REFERENCE TO RELATED APPLICATIONS

The present application is a continuation application of International Application No. PCT/JP2022/016549 filed on Mar. 31, 2022, which is based on and claims priority from Japanese Patent Application No. 2021-064255 filed on Apr. 5, 2021. The entire contents of these applications are incorporated by reference into the present application.

### BACKGROUND

### 1 Technical Field

The present disclosure relates to interior permanent magnet rotors and rotating electric machines.

### 2 Description of Related Art

There is known a rotating electric machine that employs an Interior Permanent Magnet (IPM) rotor. The IPM rotor has permanent magnets embedded in a rotor core. Consequently, it becomes possible to obtain both magnet torque generated by the permanent magnets and reluctance torque generated by outer core portions located radially outside the permanent magnets.

### SUMMARY

According to a first aspect of the present disclosure, a rotor is provided which includes a rotor core and permanent magnets embedded in the rotor core. The rotor has a plurality of magnetic poles arranged in a circumferential direction. Each of the magnetic poles includes one of the permanent magnets and one of outer core portions; the outer core portions are portions of the rotor core which are located radially outside the permanent magnets. Each of the outer core portions has a radially outer surface that has an arc shape in an axial view; the arc shape is such that the radially outer surface becomes closer to a rotation axis of the rotor as it extends from a magnetic-pole center of the magnetic pole toward both sides in the circumferential direction. The rotor core has a maximum diameter at the magnetic-pole center. A circle having a diameter equal to the maximum diameter of the rotor core and centering on the rotation axis is defined as a reference circle. An outer circumferential surface of the rotor core has, at intersections between the arc-shaped radially outer surfaces of the outer core portions adjacent to one another in the circumferential direction, maximum displacement portions that are most displaced from the reference circle radially inward. A displacement amount of the maximum displacement portions from the reference circle is smaller than a maximum thickness of the permanent magnets in an axial view.

According to a second aspect of the present disclosure, a rotating electric machine is provided which includes a stator and the above-described rotor that is arranged radially inside the stator.

### BRIEF DESCRIPTION OF THE DRAWINGS

FIG. 1 is a configuration diagram of a rotating electric machine which includes an IPM rotor according to an embodiment.

FIG. 2 is a configuration diagram of the rotor according to the embodiment.

FIG. 3 is a cross-sectional view of the rotor according to the embodiment.

FIG. 4 is a perspective view of the rotor according to the embodiment.

FIG. 5 is an explanatory diagram for explaining the characteristics of the rotor according to the embodiment.

FIG. 6 is another explanatory diagram for explaining the characteristics of the rotor according to the embodiment.

FIG. 7 is yet another explanatory diagram for explaining the characteristics of the rotor according to the embodiment.

FIG. 8 is an explanatory diagram for explaining the characteristics of the rotating electric machine according to the embodiment.

### DESCRIPTION OF EMBODIMENTS

The inventors of the present application have investigated how to reduce cogging torque generated in a rotating electric machine which employs an IPM rotor known in the art (see, for example, Japanese Patent No. JP4898201B).

The present disclosure has been accomplished based on the results of the investigation by the inventors of the present application.

In the above-described rotor and rotating electric machine according to the present disclosure, since each of the radially outer surfaces of the outer core portions has the arc shape such that the radially outer surface becomes closer to the rotation axis of the rotor as it extends from the magnetic-pole center of the magnetic pole toward both sides in the circumferential direction, switching of the magnetic poles becomes smooth. Consequently, it becomes possible to suppress generation of the cogging torque. Moreover, with the above configuration, it becomes possible to reduce the cogging torque as compared with the case of the displacement amount of the maximum displacement portions from the reference circle being larger than the maximum thickness of the permanent magnets.

Hereinafter, an exemplary embodiment of the rotor and the rotating electric machine will be described.

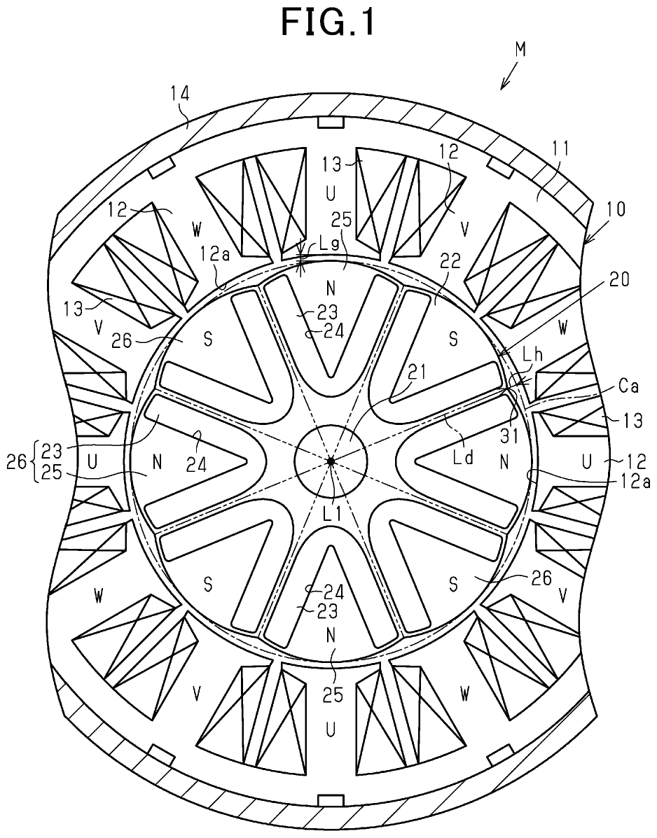

As shown in FIG. 1, a rotating electric machine M according to the present embodiment is configured as an IPM brushless motor. The rotating electric machine M includes a substantially annular stator 10 and a substantially cylindrical rotor 20 that is rotatably arranged in a space radially inside the stator 10.

(Configuration of Stator 10)

The stator 10 includes a substantially annular stator core 11. The stator core 11 is formed of a magnetic metal material. More particularly, the stator core 11 is formed by laminating a plurality of magnetic steel sheets in an axial direction. In the present embodiment, the stator core 11 has twelve teeth 12 extending radially inward and arranged at equal intervals in a circumferential direction. That is, in the stator 10, there are formed twelve slots in which windings are wound. All the teeth 12 are identical in shape to each other. Each of the teeth 12 has a substantially T-shaped radially inner end portion (i.e., distal end portion) and a distal end surface 12a formed in an arc shape along an outer circumferential surface of the rotor 20.

Windings 13 are wound around the teeth 12 in a concentrated winding manner. The windings 13 are connected in three phases to respectively function as a U-phase, a V-phase and a W-phase as shown in FIG. 1. Upon supply of electric power to the windings 13, the stator 10 generates a rotating magnetic field, thereby driving the rotor 20 to rotate. In the stator 10, an outer circumferential surface of the stator core 11 is fixed to an inner circumferential surface of a housing 14.

(Configuration of Rotor 20)

The rotor 20 includes a rotating shaft 21, and a substantially cylindrical rotor core 22 having the rotating shaft 21 inserted in a central part thereof. Moreover, the rotor 20 further includes a plurality (more particularly, eight in the present embodiment) of permanent magnets 23 embedded in the rotor core 22. The rotor core 22 is formed of a magnetic metal material. More particularly, the rotor core 22 is formed by laminating a plurality of magnetic steel sheets in the axial direction. The rotor 20 is rotatably arranged with respect to the stator 10, with the rotating shaft 21 supported by bearings (not shown) provided in the housing 14.

The rotor core 22 has a plurality of magnet-receiving holes 24 for receiving the permanent magnets 23 therein. More particularly, in the present embodiment, eight magnet-receiving holes 24 are formed at equal intervals in the circumferential direction of the rotor core 22. Each of the magnet-receiving holes 24 has a folded substantially V-shape that is convex radially inward. That is, all the magnet-receiving holes 24 are identical in shape to each other. Moreover, each of the magnet-receiving holes 24 is formed to extend over the entire axial length of the rotor core 22.

In the present embodiment, the permanent magnets 23 are implemented by bonded magnets that are formed by molding and solidifying a magnet material; the magnet material is a mixture of a magnet powder and a resin. More specifically, in the present embodiment, the magnet-receiving holes 24 of the rotor core 22 serve as forming molds. The permanent magnets 23 are formed by: filling the magnet material, which has not been solidified, into the magnet-receiving holes 24 of the rotor core 22 by injection molding without any gaps remaining therein; and then solidifying the magnet material in the magnet-receiving holes 24. Consequently, the external shape of the permanent magnets 23 conforms to the shape of the magnet-receiving holes 24 of the rotor core 22. In the present embodiment, a samarium-iron-nitrogen-based (i.e., SmFeN-based) magnet powder is employed as the magnet powder for forming the permanent magnets 23. It should be noted that other rare-earth magnet powders may alternatively be employed as the magnet powder for forming the permanent magnets 23.

As shown in FIG. 1, those portions of the rotor core 22 which are located radially outside the permanent magnets 23, i.e., those portions of the rotor core 22 which face the stator 10 function as outer core portions 25 to generate reluctance torque. The rotor 20 has a plurality of magnetic poles 26 each including one of the permanent magnets 23 and one of the outer core portions 25. That is, the number of the magnetic poles 26 is equal to the number of the permanent magnets 23, i.e., equal to eight in the present embodiment. In other words, the number of poles of the rotor is equal to eight. All the magnetic poles 26 are identical in shape to each other. Moreover, the magnetic poles 26 are arranged at equal intervals in the circumferential direction. As shown in FIG. 1, the magnetic poles 26 function as N poles and S poles alternately in the circumferential direction. The rotor 20, which is configured to have the magnetic poles 26 as described above, can generate both magnet torque and reluctance torque.

(Configuration of Magnetic Poles 26)

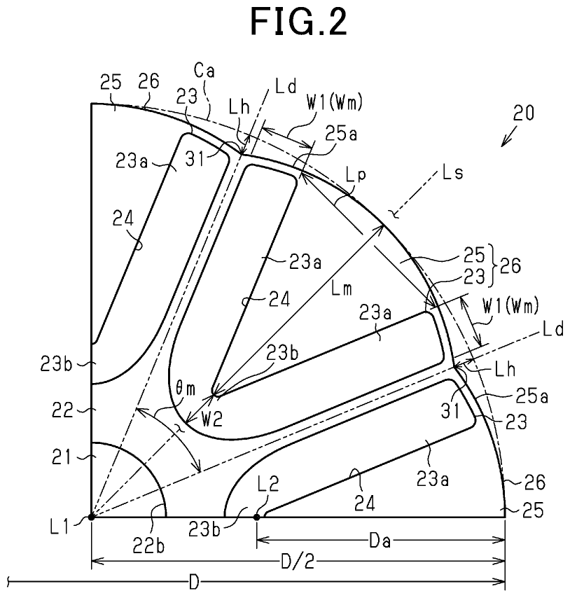

As shown in FIG. 2, each of the magnetic poles 26 has a magnetic-pole center Ls in the circumferential direction. The magnetic-pole centers Ls of the magnetic poles 26 are set at equal intervals in the circumferential direction. More particularly, in the present embodiment, the magnetic-pole centers Ls of the eight magnetic poles 26 are set at intervals of 45° in the circumferential direction. Each magnetic pole 26 is adjacent to neighboring magnetic poles 26 with magnetic-pole boundary lines Ld representing the boundaries therebetween in the circumferential direction. Each of magnetic-pole boundary lines Ld between the magnetic poles 26 is perpendicular to a rotation axis L1 of the rotor 20. Moreover, in the present embodiment, the eight magnetic-pole boundary lines Ld are set at intervals of 45° in the circumferential direction. Furthermore, the angle between each adjacent pair of the magnetic-pole boundary lines Ld, i.e., the magnetic-pole opening angle θm of each of the magnetic poles 26 is 180° in electrical angle.

The outer diameter of the rotor core 22, i.e., the distance from the rotation axis L1 to the outer circumferential surface of the rotor core 22 is not constant in the circumferential direction. Specifically, the outer diameter of the rotor core 22 is largest at each of the magnetic-pole centers Ls and smallest at each of magnetic-pole boundary lines Ld. In FIGS. 1 and 2, a circle whose diameter is equal to a maximum diameter of the rotor core 22 is shown as a reference circle Ca. Moreover, in FIG. 2, the diameter of the reference circle Ca is denoted by D; and the radius of the reference circle Ca is denoted by D/2.

In each of the magnetic poles 26, the outer core portion 25 has an outer surface 25a that is a radially outer surface. The outer surface 25a is a surface that faces the distal end surfaces 12a of the teeth 12. When viewed in the axial direction, the outer surface 25a has an arc shape centering on a central axis L2. The central axis L2 of the arc defining the outer surface 25a is an axis which is parallel to the rotation axis L1 of the rotor 20, but not coincident with the rotation axis L1. Moreover, the central axis L2 is set within an area surrounded by the reference circle Ca. Furthermore, the radius Da of the arc defining the outer surface 25a is smaller than the radius (D/2) of the reference circle Ca.

The outer circumferential surface of the rotor core 22 is furthest from the reference circle Ca at intersections between the outer surfaces 25a of the outer core portions 25 adjacent to one another in the circumferential. Hereinafter, the intersections will be referred to as the maximum displacement portions 31; and the distance from the reference circle Ca to each of the maximum displacement portions 31 will be referred to as the displacement amount Lh of the maximum displacement portions 31.

(Configuration of Permanent Magnets 23)

Each of the permanent magnets 23 has a folded substantially V-shape that is convex radially inward. More specifically, as shown in FIG. 2, each of the permanent magnets 23 has a shape such that the radially inner ends of a pair of straight portions 23a are connected by a curved portion 23b. The radially outer ends of the pair of straight portions 23a are located near the outer circumferential surface of the rotor core 22. Moreover, each of the permanent magnets 23 has a line-symmetric shape with respect to the corresponding magnetic-pole center Ls. Furthermore, the straight portions 23a of the permanent magnets 23 are located in close proximity to the corresponding magnetic-pole boundary lines Ld.

Let W1 be the thickness of each of the straight portions 23a in an axial view of the permanent magnet 23. Let W2 be the thickness of the curved portion 23b in an axial view of the permanent magnet 23. The thickness W1 of each of the straight portions 23a is the thickness in directions perpendicular to the extending direction of the straight portion 23a in an axial view. The thickness W1 of each of the straight portions 23a may be set to be, for example, constant in the extending direction of the straight portion 23a. Moreover, the thickness W1 may be set to be, for example, equal for all the straight portions 23a of the permanent magnets 23. The thickness W2 of the curved portion 23b is the thickness of the curved portion 23b at the corresponding magnetic-pole center Ls. In the present embodiment, the thickness W1 of each of the straight portions 23a is set to be larger than the thickness W2 of the curved portion 23b. That is, when viewed in the axial direction, each of the permanent magnets 23 has a maximum thickness Wm that is represented by the thickness W1 of each of the straight portions 23a. In addition, in each of the magnetic poles 26, the position of the central axis L2 of the arc defining the outer surface 25a of the outer core portion 25 is set to overlap the curved portion 23b of the permanent magnet 23.

For each of the V-shaped permanent magnets 23, the distance between the intersection points between extension lines of inside surfaces of the straight portions 23a of the permanent magnet 23 and the outer circumferential surface of the rotor core 22 is defined as a magnetic pole pitch Lp; and the distance from the outer circumferential surface of the rotor core 22 to an inside surface of the curved portion 23b of the permanent magnet 23 at the corresponding magnetic-pole center Ls is defined as an embedding depth Lm. In the present embodiment, each of the permanent magnets 23 is formed to have a deep folded shape such that the embedding depth Lm is larger than the magnetic pole pitch Lp. That is, in the present embodiment, for each of the V-shaped permanent magnets 23, the magnet surface of the permanent magnet 23, which is constituted of the inside surfaces of the straight portions 23a and curved portion 23b of the permanent magnet 23, is set to be larger than the magnet surface of a well-known surface permanent magnet rotor (not shown). Setting the embedding depth Lm to be large, the curved portions 23b of the permanent magnets 23 are located radially inward near a shaft insertion hole 22b which is formed in the central part of the rotor core 22 and in which the rotating shaft 21 is inserted. It should be noted that: the above-described folded shape is merely an example of the shape of the permanent magnets 23; and the permanent magnets 23 may be suitably modified to have other shapes, such as a folded substantially V-shape with a small embedding depth Lm or a folded substantially U-shape with a large curve portion 23b.

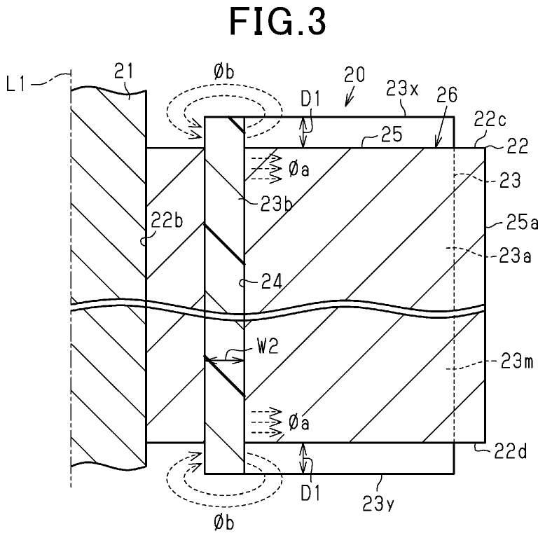

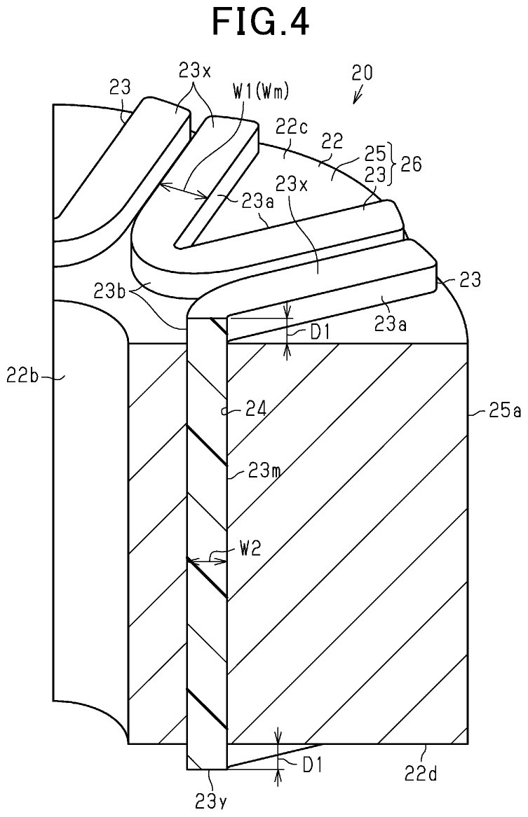

As shown in FIGS. 3 and 4, each of the permanent magnets 23 is formed to partially protrude from a pair of axial end faces 22c and 22d of the rotor core 22. More specifically, each of the permanent magnets 23 has an embedded magnet portion 23m located in a corresponding one of the magnet-receiving holes 24 of the rotor core 22 and a pair of protruding portions 23x and 23y that protrude respectively from the axial end faces 22c and 22d of the rotor core 22. In addition, the axial end faces 22c and 22d of the rotor core 22 are formed as flat surfaces. The protruding portions 23x and 23y of the permanent magnets 23 can be easily realized by providing, in forming molds (not shown) for closing the magnet-receiving holes 24 that open to the axial end faces 22c and 22d of the rotor core 22, recesses for forming the protruding portions 23x and 23y.

For each of the permanent magnets 23, the protruding portions 23x and 23y are formed in all of the straight portions 23a and curved portion 23b of the permanent magnet 23. More specifically, the protruding portions 23x and 23y are formed continuously along the V-shaped path including the straight portions 23a and curved portion 23b of the permanent magnet 23. Moreover, the protruding portions 23x and 23y are formed respectively on the pair of axial end faces 22c and 22d of the rotor core 22. Furthermore, the protruding portions 23x and 23y are formed of the same material as that of the embedded magnet portion 23m of the permanent magnet 23 which is located in the corresponding magnet-receiving hole 24 of the rotor core 22, and are formed continuously and integrally with the embedded magnet portion 23m of the permanent magnet 23.

The protruding portions 23x and 23y of the permanent magnets 23 are end portions of the permanent magnets 23 which are located on the axial end faces 22c and 22d of the rotor core 22. The protruding portions 23x and 23y of the permanent magnets 23 function to cause leakage magnetic flux (rib as shown in FIG. 3 to be generated thereat; the leakage magnetic flux (rib tends to be generated at the ends of the permanent magnets 23. In other words, with the protruding portions 23x and 23y, more of the magnetic flux generated by the embedded magnet portions 23m of the permanent magnets 23, which are located in the rotor core 22, flows radially without leaking out from the axial end faces 22c and 22d of the rotor core 22; thus, more of the magnetic flux becomes effective magnetic flux (pa that contributes to the torque of the rotating electric machine M. The protruding portions 23x and 23y are formed to have a proper protruding amount D1 from the axial end faces 22c and 22d of the rotor core 22 while enabling an increase in the amount of the effective magnetic flux φa. It should be noted that the protruding amount D1 of the protruding portions 23x and 23y shown in the drawings may be different from the actual protruding amount D1.

The permanent magnets 23, which are provided mainly in the magnet-receiving holes 24 of the rotor core 22, are magnetized, after solidification of the magnet material, by a magnetizing apparatus (not shown) located outside the rotor core 22, so as to function as genuine permanent magnets. More specifically, the eight permanent magnets 23 are magnetized so that the polarities of the permanent magnets 23 are alternately different in the circumferential direction. In addition, each of the permanent magnets 23 is magnetized in its thickness direction.

Next, operation of the rotor 20 of the rotating electric machine M according to the present embodiment will be described.

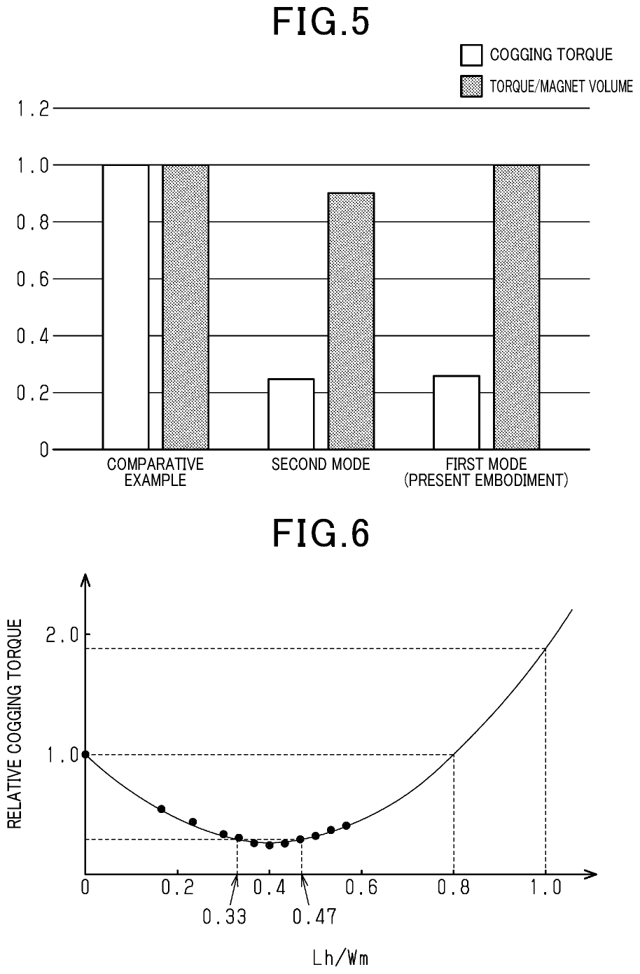

FIG. 5 shows the results of a comparison between a first mode, which is the present embodiment, a second mode and a comparative example.

The first mode is the above-described embodiment. That is, in the first mode, the outer circumferential surface of the rotor core 22 has the above-described configuration, i.e., the configuration where in each of the magnetic poles 26, the outer surface 25a of the outer core portion 25 has the arc shape centering on the central axis L2. Moreover, in the first mode, a configuration is further employed where the end portions of the permanent magnets 23 protrude, as the protruding portions 23x and 23y, from the axial end faces 22c and 22d of the rotor core 22 respectively on opposite axial sides of the rotor core 22.

The second mode employs a configuration where the protruding portions 23x and 23y of the permanent magnets 23 are omitted from the configuration according to the first mode, i.e., employs a configuration where the permanent magnets 23 do not protrude from the magnet-receiving holes 24 in the axial direction. However, in the second mode, the shape of the outer circumferential surface of the rotor core 22 in an axial view is the same as that in the first mode.

The comparative example employs a configuration where the outer circumferential surface of the rotor core 22 has a circular shape along the reference circle Ca in an axial view. Moreover, the comparative example further employs a configuration where the end portions of the permanent magnets 23 do not protrude from the axial end faces 22c and 22d of the rotor core 22.

FIG. 5 shows both the magnitude of cogging torque generated in the rotating electric machine and the ratio of the torque of the rotating electric machine to the volume of the permanent magnets 23 (i.e., torque/magnet volume) in each of the comparative example, the first mode and the second mode. It should be noted that in FIG. 5, the first and second modes are compared with the comparative example using relative values of the parameters which are 1.0 in the comparative example. As can be seen from FIG. 5, the cogging torque is considerably reduced in both the first and second modes as compared with the comparative example. Moreover, the cogging torque is slightly lower in the second mode than in the first mode.

FIG. 6 illustrates the relationship between the ratio (Lh/Wm) of the displacement amount Lh to the maximum thickness Wm of the permanent magnets 23 and the magnitude of the cogging torque. It should be noted that the ratio (Lh/Wm) is zero, i.e., the displacement amount Lh is zero in the configuration employed in the comparative example where the outer circumferential surface of the rotor core 22 has a circular shape along the reference circle Ca in an axial view. Moreover, it also should be noted that the vertical axis in FIG. 6 represents the relative cogging torque that is 1.0 when the ratio (Lh/Wm) is zero.

As can be seen from FIG. 6, in the case of the ratio (Lh/Wm) being lower than 1.0, the relative cogging torque is reduced as compared with the case of the ratio (Lh/Wm) being higher than or equal to 1.0. The relative cogging torque quadratically decreases as the ratio (Lh/Wm) decreases from 1.0 to about 0.4, and becomes lowest when the ratio (Lh/Wm) is about 0.4. Then, the relative cogging torque quadratically increases as the ratio (Lh/Wm) decreases from about 0.4 to zero.

When the ratio (Lh/Wm) is 0.8, the relative cogging torque is 1.0. That is, in the range of 0<(Lh/Wm)<0.8, the relative cogging torque is lower than 1.0. Therefore, setting the ratio (Lh/Wm) to be in the range of 0<(Lh/Wm)<0.8, it is possible to reduce the cogging torque as compared with the configuration employed in the comparative example where the displacement amount Lh is zero.

Moreover, when the ratio (Lh/Wm) is in the range of 0.33≤(Lh/Wm)≤0.47, the relative cogging torque is about 0.3 or lower. That is, setting the ratio (Lh/Wm) to be in the range of 0.33≤(Lh/Wm)≤0.47, it is possible to reduce the cogging torque to be about ⅓ of that in the comparative example employing the configuration where the displacement amount Lh is zero. In addition, it is preferable for the ratio (Lh/Wm) to be set to 0.4 at which the relative cogging torque is lowest. Further, even considering manufacturing tolerances, it is preferable for the ratio (Lh/Wm) to be set to be in the range of 0.33≤(Lh/Wm)≤0.47.

As can be seen from FIG. 5, the ratio (torque/magnet volume) in the second mode is slightly lower than that in the comparative example. The ratios (torque/magnet volume) in the first mode and the comparative example are almost equal to each other, and are higher than that in the second mode.

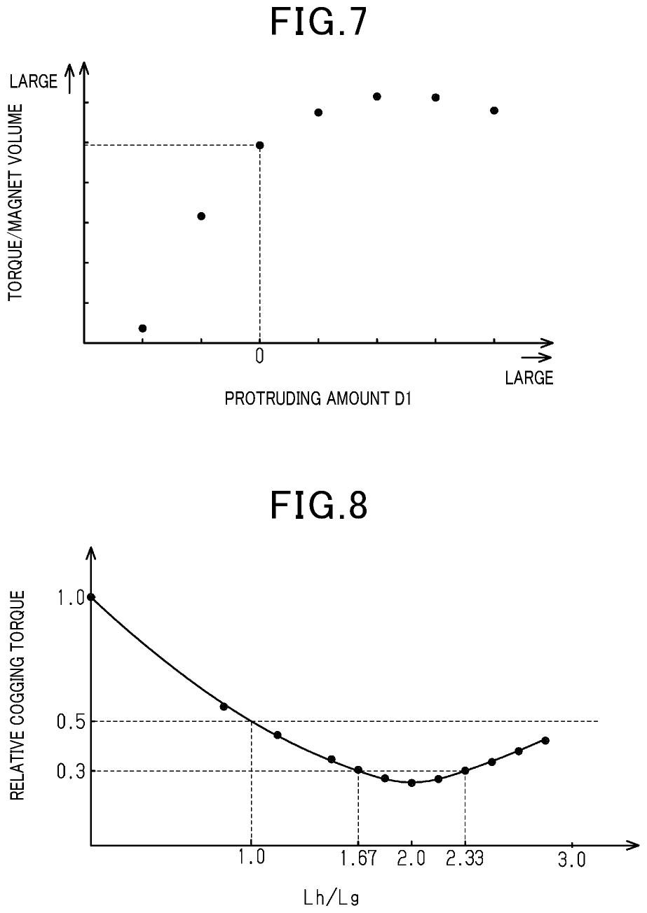

FIG. 7 illustrates the relationship between the protruding amount D1 of the protruding portions 23x and 23y and the ratio (torque/magnet volume) in the above-described embodiment. As can be seen from FIG. 7, setting the protruding amount D1 of the protruding portions 23x and 23y to be larger than zero, i.e., providing the protruding portions 23x and 23y in the permanent magnets 23, the amount of the effective magnetic flux (pa increases and thus the ratio (torque/magnet volume) also increases. Moreover, when the protruding amount D1 is larger than zero, the ratio (torque/magnet volume) first increases with increase in the protruding amount D1, and then gradually decreases with increase in the protruding amount D1. This can be considered to be a result of suppressing the magnet volume by setting the thickness W2 of the curved portion 23b to be smaller than the thickness W1 of the straight portions 23a in each of the permanent magnets 23 while suppressing the magnetic flux generated by the embedded magnet portions 23m of the permanent magnets 23 from leaking out from the axial end faces 22c and 22d of the rotor core 22. The protruding amount D1 is set to a proper value in consideration of the relationship with the ratio (torque/magnet volume) as shown in FIG. 7. Moreover, with increase in the protruding amount D1, the weight of the rotor 20 and the amount of the magnet material for forming the permanent magnets 23 also increase; therefore, it is preferable to set the protruding amount D1 properly taking into account this fact as well.

FIG. 8 illustrates the relationship between the ratio (Lh/Lg) of the displacement amount Lh to an air gap Lg and the magnitude of the cogging torque. It should be noted that the ratio (Lh/Lg) is zero, i.e., the displacement amount Lh is zero in the configuration employed in the comparative example where the outer circumferential surface of the rotor core 22 has a circular shape along the reference circle Ca in an axial view. Moreover, it also should be noted that the vertical axis in FIG. 8 represents the relative cogging torque that is 1.0 when the ratio (Lh/Lg) is zero. As shown in FIG. 1, the air gap Lg is represented by the difference between the inner radius of the stator 10 and the radius D/2 of the reference circle Ca. In addition, the inner radius of the stator 10 is represented by the distance from the rotation axis L1 to any of the distal end surfaces 12a of the teeth 12.

As shown in FIG. 8, the relative cogging torque quadratically decreases as the ratio (Lh/Lg) increases from zero to about 2.0, and becomes lowest when the ratio (Lh/Lg) is about 2.0. Then, the relative cogging torque quadratically increases as the ratio (Lh/Lg) increases from about 2.0. When the ratio (Lh/Lg) is higher than zero, the relative cogging torque is lower than 1.0. Therefore, with the configuration where the displacement amount Lh is larger than zero, it is possible to reduce the cogging torque as compared with the configuration employed in the comparative example where the displacement amount Lh is zero.

In the case of the ratio (Lh/Lg) being higher than or equal to 1.0, the relative cogging torque is reduced as compared with the case of the ratio (Lh/Lg) being lower than 1.0. When the ratio (Lh/Lg) is in the range of 1.0≤(Lh/Lg), the relative cogging torque is lower than or equal to 0.5. Therefore, setting the displacement amount Lh to be larger than or equal to the air gap Lg, it is possible to reduce the cogging torque by half as compared with the configuration employed in the comparative example where the displacement amount Lh is zero.

Moreover, when the ratio (Lh/Lg) is in the range of 1.67≤(Lh/Lg)≤2.33, the relative cogging torque is about 0.3 or lower. That is, setting the ratio (Lh/Lg) to be in the range of 1.67≤(Lh/Lg)≤2.33, it is possible to reduce the cogging torque to be about ⅓ of that in the comparative example employing the configuration where the displacement amount Lh is zero. In addition, it is preferable for the ratio (Lh/Lg) to be set to about 2.0 at which the relative cogging torque is lowest. Further, even considering manufacturing tolerances, it is preferable for the ratio (Lh/Lg) to be set to be in the range of 1.67≤(Lh/Lg)≤2.33.

(Relationship Between Radius of Reference Circle Ca and Maximum Thickness Wm of Permanent Magnets 23)

The inventors of the present application have investigated the correlation between the ratio (Wm/(D/2)) of the maximum thickness Wm of the permanent magnets 23 to the radius D/2 of the reference circle Ca and the magnet torque. As a result, the inventors have obtained a range represented by the following formula (a) as a range of the ratio (Wm/(D/2)) within which a suitable magnet torque can be obtained.

−0.0006D+0.1626−0.5/(D/2)≤Wm/(D/2)≤−0.0006D+0.1626+0.5/(D/2) (a)

Therefore, based on the above formula (a), it is possible to easily set, according to the specifications of the rotating electric machine M, the maximum thickness Wm of the permanent magnets 23 suitable for the diameter D of the reference circle Ca, i.e., suitable for the maximum diameter of the rotor core 22.

Next, advantageous effects of the present embodiment will be described.
(1) In the rotor 20, the displacement amount Lh of the maximum displacement portions 31 from the reference circle Ca is smaller than the maximum thickness Wm of the permanent magnets 23 in an axial view. With this configuration, since each of the radially outer surfaces 25a of the outer core portions 25 has the arc shape such that the radially outer surface 25a becomes closer to the rotation axis L1 of the rotor 20 as it extends from the magnetic-pole center Ls of the magnetic pole 26 toward both sides in the circumferential direction, switching of the magnetic poles 26 becomes smooth. Consequently, it becomes possible to suppress generation of the cogging torque. Moreover, with the above configuration, it becomes possible to reduce the cogging torque as compared with the case of the displacement amount Lh of the maximum displacement portions 31 from the reference circle Ca being larger than the maximum thickness Wm of the permanent magnets 23. In addition, in the present embodiment, the displacement amount Lh is changed by changing the radius Da of the arc defining the outer surface 25a in each of the magnetic poles 26. For example, the larger the radius Da is set in each of the magnetic poles 26, the smaller the displacement amount Lh will become.
(2) Each of the permanent magnets 23 has the folded shape that is convex radially inward. With this configuration, it becomes possible to secure a large surface area of the permanent magnets 23 facing the outer core portions 25. Consequently, it becomes possible to increase the magnet torque.
(3) The axial end faces 22c and 22d of the rotor core 22 are formed as flat surfaces. Moreover, each of the permanent magnets 23 has the protruding portions 23x and 23y that protrude respectively from the axial end faces 22c and 22d of the rotor core 22. With this configuration, since the protruding portions 23x and 23y are provided at the ends of the permanent magnets 23, the leakage magnetic flux ppb generated at the ends of the permanent magnets 23 will be concentrated on the protruding portions 23x and 23y of the permanent magnets 23. Moreover, to leak out from the axial end faces 22c and 22d of the rotor core 22, it would be necessary for the magnetic flux generated by the embedded magnet portions 23m of the permanent magnets 23, which are located in the rotor core 22, to flow beyond the protruding portions 23x and 23y. That is, the lengths of the paths through which the magnetic flux may leak out are increased. Consequently, it becomes possible to suppress the magnetic flux generated by the embedded magnet portions 23m from leaking out from the axial end faces 22c and 22d of the rotor core 22; thus, it becomes possible for the magnetic flux generated by the embedded magnet portions 23m to radially flow through the rotor core 22 over the entire axial length thereof. As a result, most of the magnetic flux generated by the embedded magnet portions 23m becomes the effective magnetic flux φa that contributes to the torque of the rotating electric machine M; thus, it becomes possible to increase the amount of the effective magnetic flux φa.
(4) The ratio (Lh/Wm) of the displacement amount Lh to the maximum thickness Wm of the permanent magnets 23 satisfies 0<(Lh/Wm)<0.8. With this configuration, it becomes possible to reduce the cogging torque as compared with the comparative configuration where the displacement amount Lh is zero.
(5) The ratio (Lh/Wm) of the displacement amount Lh to the maximum thickness Wm of the permanent magnets 23 satisfies 0.33≤(Lh/Wm)≤0.47. With this configuration, it becomes possible to reduce the cogging torque to be about ⅓ of that in the case of employing the comparative configuration where the displacement amount Lh is zero. Moreover, setting the ratio (Lh/Wm) to be in the range of 0.33≤(Lh/Wm)≤0.47, it will be possible to stably achieve the effect of reducing the cogging torque even when the ratio (Lh/Wm) is deviated from 0.4 due to manufacturing tolerances.
(6) The displacement amount Lh is set to be larger than or equal to the air gap Lg that is the difference between the inner radius of the stator 10 and the radius of the reference circle Ca. With this configuration, it becomes possible to reduce the cogging torque as compared with the configuration where the displacement amount Lh is smaller than the air gap Lg.
(7) The ratio (Lh/Lg) of the displacement amount Lh to the air gap Lg satisfies 1.67≤(Lh/Lg)≤2.33. With this configuration, it becomes possible to reduce the cogging torque to be about ⅓ of that in the case of employing the configuration where the displacement amount Lh is zero. Moreover, setting the ratio (Lh/Lg) to be in the range of 1.67≤(Lh/Lg)≤2.33, it will be possible to stably achieve the effect of reducing the cogging torque even when the ratio (Lh/Lg) is deviated from 2.0 due to manufacturing tolerances.
(8) The number of the magnetic poles 26 of the rotor 20 is eight, and the stator 10 has the twelve slots in which the windings are wound. With this configuration, it becomes possible to reduce the cogging torque generated in the 8-pole 12-slot rotating electric machine M.

The present embodiment can be modified and implemented as follows. Moreover, the present embodiment and the following modifications can also be implemented in combination with each other to the extent that there is no technical contradiction between them.

In the above-described embodiment, the thickness W1 of the straight portions 23a is set to be larger than the thickness W2 of the curved portion 23b in each of the permanent magnets 23. However, the present disclosure is not limited to this configuration. As an alternative, the thickness W1 of the straight portions 23a may be set to be equal to the thickness W2 of the curved portion 23b in each of the permanent magnets 23. As another alternative, the thickness W1 of the straight portions 23a may be set to be smaller than the thickness W2 of the curved portion 23b in each of the permanent magnets 23. In this case, when viewed in the axial direction, each of the permanent magnets 23 has a maximum thickness Wm that is represented by the thickness W2 of the curved portion 23b.

The configuration of the protruding portions 23x and 23y, which are provided at the ends of the permanent magnets 23 to protrude respectively from the axial end faces 22c and 22d of the rotor core 22, may be modified as appropriate. For example, in each of the permanent magnets 23, the protruding portions 23x and 23y may formed only at part of the V-shaped path including the straight portions 23a and curved portion 23b of the permanent magnet 23. As another example, in each of the permanent magnets 23, one of the protruding portions 23x and 23y may be omitted. As yet another example, in each of the permanent magnets 23, the protruding portions 23x and 23y may be provided partially in the thickness direction of the permanent magnet 23 perpendicular to the extending direction of the V-shaped path of the permanent magnet 23. As still another example, in each of the permanent magnets 23, the protruding amount D1 of the protruding portions 23x and 23y may be set to be not constant in the extending direction of the V-shaped path of the permanent magnet 23. As another example, in each of the permanent magnets 23, the protruding portions 23x and 23y may be formed separately from the embedded magnet portion 23m. In this case, different magnet materials may be used respectively for the protruding portions 23x and 23y and the embedded magnet portion 23m. As yet another example, the protruding portions 23x and 23y, which protrude respectively from the axial end faces 22c and 22d of the rotor core 22, are not necessarily provided in all of the permanent magnets 23 arranged in the circumferential direction of the rotor 20.

The shape of the permanent magnets 23 is not limited to that in the above-described embodiment, and may be modified as appropriate according to the specifications of the rotating electric machine M. For example, the shape of the permanent magnets 23 as viewed in the axial direction may be other folded shapes (e.g., a U-shape) that are convex radially inward. As another example, the shape of the permanent magnets 23 as viewed in the axial direction may be a curved shape that is convex radially outward. As yet another example, each of the permanent magnets 23 may have a substantially rectangular parallelepiped shape, and may be arranged so that one side face of the permanent magnet 23 is perpendicular to a straight line passing through both the rotation axis L1 and the corresponding magnetic-pole center Ls.

The number of the permanent magnets 23 included in each of the magnetic poles 26 is not limited to one. For example, in each of the magnetic poles 26, the curved portion 23b of the permanent magnet 23 may be omitted so that the straight portions 23a of the permanent magnet 23 are separated from each other.

In the above-described embodiment, the permanent magnets 23 are formed by injection-molding the magnet material into the magnet-receiving holes 24 of the rotor core 22. Alternatively, the permanent magnets 23 may be manufactured in advance and inserted into and fixed in the magnet-receiving holes 24 of the rotor core 22.

In the above-described embodiment, the permanent magnets 23 are formed of the samarium-iron-nitrogen-based (i.e., SmFeN-based) magnet powder. Alternatively, the permanent magnets 23 may be formed of other rare-earth magnet powders or a ferrite powder. Moreover, in the above-described embodiment, the permanent magnets 23 are implemented by bonded magnets. Alternatively, the permanent magnets 23 may be implemented by sintered magnets.

In the above-described embodiment, the rotor core 22 is formed by laminating a plurality of magnetic steel sheets in the axial direction. Alternatively, the rotor core 22 may be formed by other methods, for example by sintering a magnetic powder.

Similarly, the above-described embodiment, the stator core 11 is formed by laminating a plurality of magnetic steel sheets in an axial direction. Alternatively, the stator core 22 may be formed by other methods, for example by sintering a magnetic powder.

The number of poles of the rotor 20 (i.e., the number of the magnetic poles 26) and the number of slots of the stator 10 are not limited to those in the above-described embodiment, and may be changed as appropriate.

Moreover, the N and S poles of the rotor 20 shown in FIG. 1 and the U, V and W phases of the stator 10 shown in FIG. 1 are merely examples, and may be changed as appropriate.

In addition to the above modifications, the configuration of the rotor 20 and the configuration of the rotating electric machine M may be further modified as appropriate.

The embodiment and modifications disclosed herein are merely examples in all respects, and the present disclosure is not limited to these examples. That is, the scope of the present disclosure is indicated by the claims, and it is intended that all modifications within the meaning and scope equivalent to the claims are also included in the scope of the present disclosure.

A technical idea that can be grasped from the above-described embodiment and modifications will be described.

A rotor is configured to satisfy the following formula:

−0.0006D+0.1626−0.5/(D/2)≤Wm/(D/2)≤−0.0006D+0.1626+0.5/(D/2),
where Wm is the maximum thickness of the permanent magnets 23, D is the diameter of the reference circle Ca, and (D/2) is the radius of the reference circle Ca.

With the above configuration, it is possible to set the maximum thickness Wm of the permanent magnets 23 for obtaining a suitable magnet torque with respect to the diameter D of the reference circle Ca (i.e., the maximum diameter of the rotor core 22).

While the present disclosure has been described pursuant to the embodiments, it should be appreciated that the present disclosure is not limited to the embodiments and the structures. Instead, the present disclosure encompasses various modifications and changes within equivalent ranges. In addition, various combinations and modes are also included in the category and the scope of technical idea of the present disclosure.

What is claimed is:

1. A rotor comprising:
a rotor core; and
permanent magnets embedded in the rotor core,
wherein:
the rotor has a plurality of magnetic poles arranged in a circumferential direction;
each of the magnetic poles includes one of the permanent magnets and one of outer core portions, the outer core portions being portions of the rotor core which are located radially outside the permanent magnets;
each of the outer core portions has a radially outer surface that has an arc shape in an axial view, the arc shape being such that the radially outer surface becomes closer to a rotation axis of the rotor as it extends from a magnetic-pole center of the magnetic pole toward both sides in the circumferential direction;
the rotor core has a maximum diameter at the magnetic-pole center;
a circle having a diameter equal to the maximum diameter of the rotor core and centering on the rotation axis is defined as a reference circle;
an outer circumferential surface of the rotor core has, at intersections between the arc-shaped radially outer surfaces of the outer core portions adjacent to one another in the circumferential direction, maximum displacement portions that are most displaced from the reference circle radially inward; and
a displacement amount of the maximum displacement portions from the reference circle is smaller than a maximum thickness of the permanent magnets in an axial view.

2. The rotor as set forth in claim 1, wherein:
each of the permanent magnets has a folded shape that is convex radially inward.

3. The rotor as set forth in claim 1, wherein:
the rotor core has axial end faces formed as flat surfaces; and
each of the permanent magnets has protruding portions that protrude respectively from the axial end faces of the rotor core.

4. The rotor as set forth in claim 1, wherein:
a ratio (Lh/Wm) of the displacement amount (Lh) to the maximum thickness (Wm) of the permanent magnets satisfies 0<(Lh/Wm)<0.8.

5. The rotor as set forth in claim 4, wherein:
the ratio (Lh/Wm) of the displacement amount to the maximum thickness of the permanent magnets satisfies 0.33≤(Lh/Wm)≤0.47.

6. A rotating electric machine comprising:
a stator; and
the rotor as set forth in claim 1, the rotor being arranged radially inside the stator.

7. The rotating electric machine as set forth in claim 6, wherein:
the displacement amount is set to be larger than or equal to an air gap that is a difference between an inner radius of the stator and a radius of the reference circle.

8. The rotating electric machine as set forth in claim 7, wherein:
a ratio (Lh/Lg) of the displacement amount (Lh) to the air gap (Lg) satisfies 1.67≤(Lh/Lg)≤2.33.

9. The rotating electric machine as set forth in claim 6, wherein:
the number of the magnetic poles of the rotor is eight; and
the stator has twelve slots in which windings are wound.
